(19) United States
(12) Patent Application Publication
(10) Pub. No.: US 2014/0245157 A1
(43) Pub. Date: Aug. 28, 2014

(54) METHOD AND APPARATUS FOR AGGREGATING DATA FOR PROVIDING CONTENT AND SERVICES VIA AUGMENTED REALITY

(71) Applicant: NOKIA CORPORATION, Espoo (FI)

(72) Inventors: Bryan Thomas Biniak, Pacific Palisades, CA (US); Don Yamato Kuramura, Redondo Beach, CA (US)

(73) Assignee: NOKIA CORPORATION, Espoo (FI)

(21) Appl. No.: 13/773,974

(22) Filed: Feb. 22, 2013

(51) Int. Cl. G06F 3/0481

(52) U.S. Cl. CPC G06F 3/0481
USPC 715/733

(57) ABSTRACT

An approach is provided for processing and presenting aggregated information to a user via an augmented reality user interface. A processing platform processes and/or facilitates a processing of location information or contextual information associated with at least one user to determine one or more parameters for causing an aggregation of information across a plurality of data sources. Further, the processing platform causes an initiation of the aggregation of the information based on the one or more parameters. Additionally, the processing platform causes a presentation of the aggregation of the information in an augmented reality user interface, wherein the aggregation of the information includes, at least in part, location-based content.

### BACKGROUND

Service providers and device manufacturers (e.g., wireless, cellular, etc.) are continually challenged to deliver value and convenience to consumers by, for example, providing compelling network services. One area of interest has been development of applications and services that process and/or utilize various data types to provide content and services to users where the data may be available from a variety of sources, for example, via social networking services, navigation services, search engines, content providers, and the like. Traditionally, users may access and/or request the data and the services from segregated sources (e.g., content providers, application providers, service providers, etc.) where a given source may not share and/or correlate its data and/or its content with other sources, which may cause disjoined data, content, and services to the users. However, as more applications, data, and services become available to the users, it becomes more challenging for the users to search for and access accurate, updated, and relevant information and services from various sources. Also, as users may request and receive a wide range of information, some applications and user devices may be capable of enhancing user experience by presenting the information as an augmented or mixed reality presentation. As a result, service providers and device manufacturers face significant technical challenges to integrating the data processing and analysis for providing users with aggregated information, content, and services via enhanced presentation methods at a user device.

### SOME EXAMPLE EMBODIMENTS

Therefore, there is a need for an approach for processing and presenting aggregated information to a user via an augmented reality user interface.

According to one embodiment, a method comprises processing and/or facilitating a processing of location information, contextual information, or a combination thereof associated with at least one user to determine one or more parameters for causing an aggregation of information across a plurality of data sources. The method also comprises causing, at least in part, an initiation of the aggregation of the information based, at least in part, on the one or more parameters. The method further comprises causing, at least in part, a presentation of the aggregation of the information in an augmented reality user interface, wherein the aggregation of the information includes, at least in part, location-based content.

According to another embodiment, an apparatus comprises at least one processor, and at least one memory including computer program code for one or more computer programs, the at least one memory and the computer program code configured to, with the at least one processor, cause, at least in part, the apparatus to processing and/or facilitating a processing of location information, contextual information, or a combination thereof associated with at least one user to determine one or more parameters for causing an aggregation of information across a plurality of data sources. The apparatus is also caused to causing, at least in part, an initiation of the aggregation of the information based, at least in part, on the one or more parameters. The apparatus is further caused to causing, at least in part, a presentation of the aggregation of the information in an augmented reality user interface, wherein the aggregation of the information includes, at least in part, location-based content.

According to another embodiment, a computer-readable storage medium carries one or more sequences of one or more instructions which, when executed by one or more processors, cause, at least in part, an apparatus to processing and/or facilitating a processing of location information, contextual information, or a combination thereof associated with at least one user to determine one or more parameters for causing an aggregation of information across a plurality of data sources. The apparatus is also caused to causing, at least in part, an initiation of the aggregation of the information based, at least in part, on the one or more parameters. The apparatus is further caused to causing, at least in part, a presentation of the aggregation of the information in an augmented reality user interface, wherein the aggregation of the information includes, at least in part, location-based content.

According to another embodiment, an apparatus comprises means for processing and/or facilitating a processing of location information, contextual information, or a combination thereof associated with at least one user to determine one or more parameters for causing an aggregation of information across a plurality of data sources. The apparatus also comprises means for causing, at least in part, an initiation of the aggregation of the information based, at least in part, on the one or more parameters. The apparatus further comprises means for causing, at least in part, a presentation of the aggregation of the information in an augmented reality user interface, wherein the aggregation of the information includes, at least in part, location-based content.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A-1C are diagrams of a system capable of processing and presenting aggregated information to a user via an augmented reality user interface, according to an embodiment;

FIG. 2 is a diagram of the components of a processing platform, according to an embodiment;

FIG. 3 is a diagram of the components of a user equipment capable of implementing one or more component for presenting content in augmented reality, according to an embodiment;

FIGS. 4 through 6 illustrate flowcharts of various processes for, at least, processing and presenting aggregated information to a user via an augmented reality user interface, according to various embodiments;

FIGS. 7A through 7F illustrate flowcharts of a process for aggregating information associated with one or more job positions, according to various embodiments;

FIGS. 8A through 8I are diagrams of user interfaces utilized in the processes of FIGS. 4 through 6, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for storing and accessing point of interest information depicted in augmented and/or mixed reality mobile applications are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

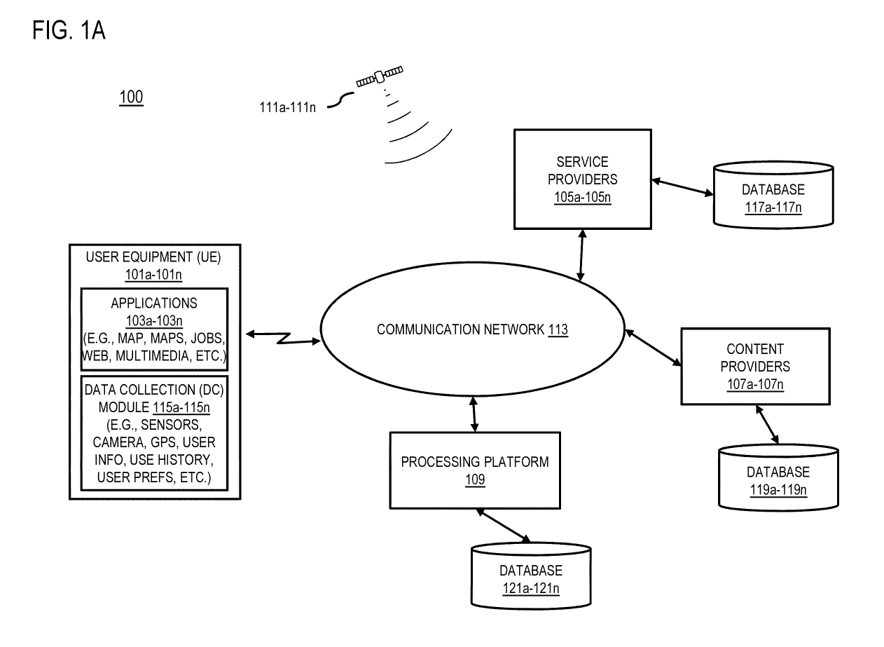

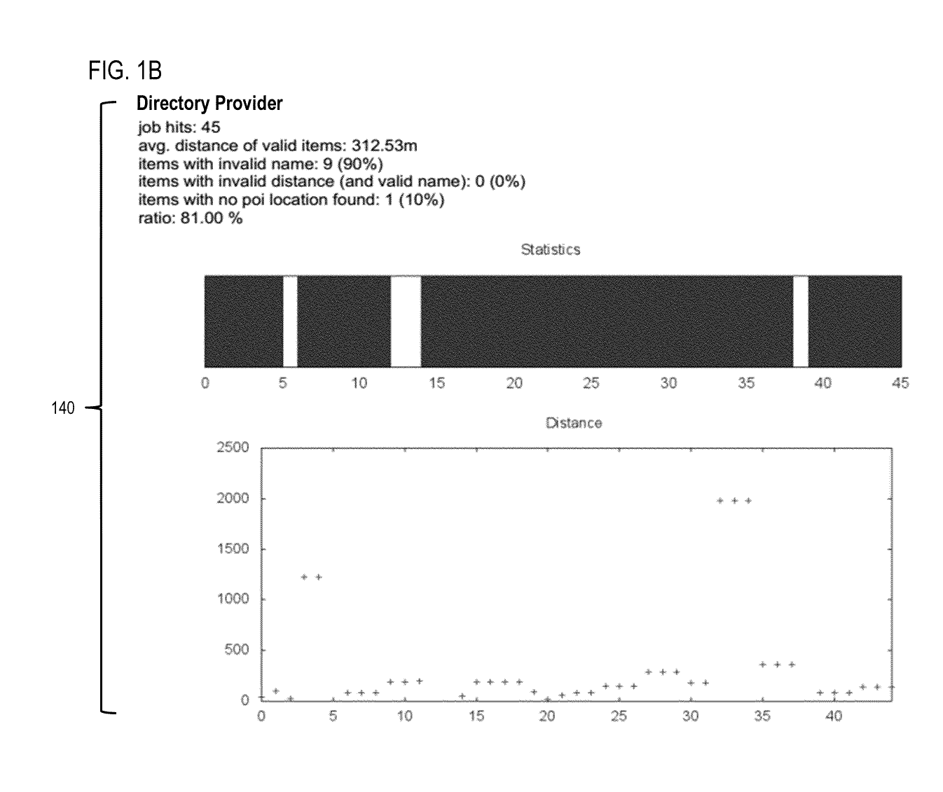

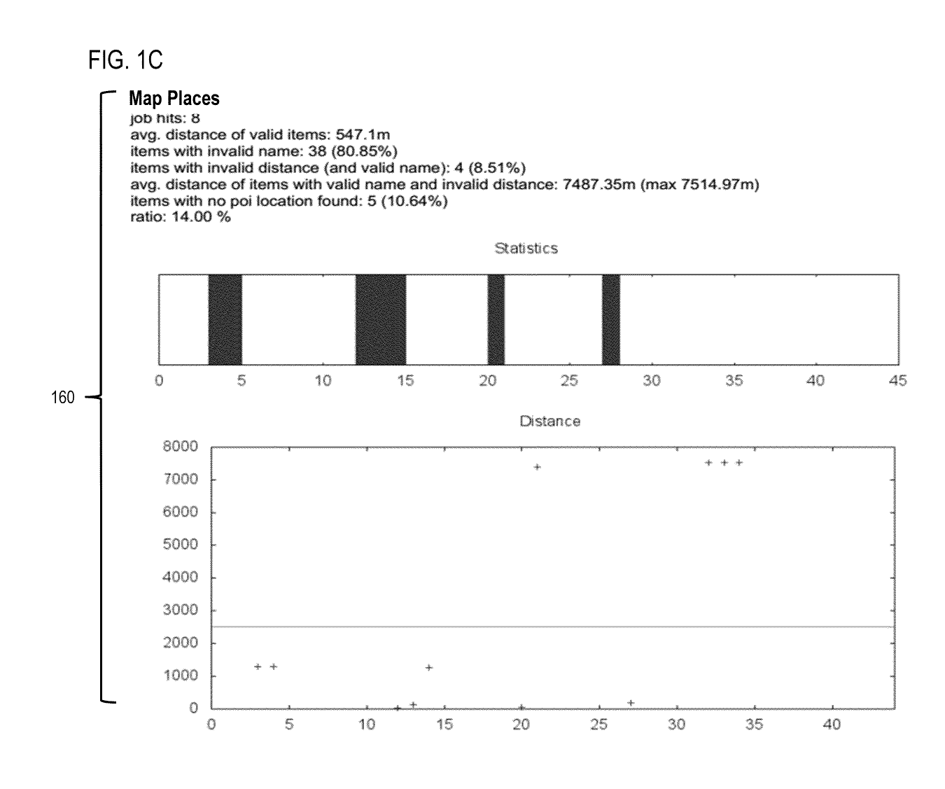

FIG. 1 is a diagram of a system capable of processing and presenting aggregated information to a user via an augmented reality user interface, according to an embodiment. As communication and Internet services are becoming readily available and accessible for users, the users may utilize those services to search for and access a plethora of content and services from various content and service providers. For example, a user may utilize a mobile device (e.g., smart phones, laptops, tablets, etc.) to search for content and services based on the user location, user activity, user profile, or other criteria, where the device may employ various applications, sensors, modules, and the like to facilitate the access, presentation, and consumption of the content and services. Further, a user device (device) may be able to detect and provide user location, user activity, user information, and the like, which may be communicated to a content or a service provider as the criteria for the content or the service request. Furthermore, some of the devices may be capable of providing an enhanced user interaction and experience by presenting the information in an augmented reality (AR), a virtual reality (VR), and/or a mixed reality (MR) environment, where the user may interact with the content via various user interface (UI) elements. However, it can be challenging for a user to search for and collect the information which may be of different types and available via disparate sources. For example, in a typical search by location information, a user may be limited to entering a zip code, a city name, or regional information where. Therefore, there is a need for a mechanism to process and present aggregated information to a user via an AR user interface.

To address, at least these problems, a system 100 of FIG. 1 introduces the capability of processing and presenting aggregated information to a user via an augmented reality user interface. More specifically, the system 100 causes an aggregation of content (e.g., information, data, services, etc.) from various sources based, at least in part, on user criteria and presenting the content to the user in an AR user interface on a device. In one use case scenario, the system 100 may determine an inquiry from a user/device requesting for information on a certain subject, wherein the requested information may include a plurality of information items, which may be available via a plurality of content providers. Further, the system 100 may process the inquiry to determine one or more content providers that may be able to provide the one or more information items associated with the requested information. Further, the system 100 may request the one or more information items from the one or more content providers so that the system 100 may further process, aggregate, and present to the user via one or more presentation methods, for example, AR, VR, MR, and the like at a user device. In general, AR allows a user's view of the real world to be overlaid with additional visual information. A key challenge in AR is to accurately track the camera pose so that the virtual objects appear registered with objects in the real environment. Although various embodiments are described with respect to AR, it is contemplated that the approach described herein may be used with other user interface situations such as MR and VR.

Some areas of interest for user enquiries may include researching information and recommendations for discovering employment, education, internship, and the like opportunities at a given geo-location, company, institution, etc. In various embodiments, the system 100 may provide a wide range of functionalities and information associated with geo-located employment opportunity postings. For example, the information may be presented in AR, VR, or MR via a mapping application; or one or more social networking site user information may be utilized in aggregating the requested information and/or functionality; or the employment opportunities may be actively monitored and recommended based on the user profile and/or recent enquiries; or the employment opportunities may be shared with friends and contacts; or previous search results may be stored via a cloud service; or the employment application process and progress may be tracked and notated; or various resumes may be generated and/or submitted; or a user may receive recent news related to the geo-location; monitor stock trends of a company of interest; or review social connections at companies posting the employment opportunities; or analyze compensation data and employment trends for similar employment positions in the related industry; or research demographics of company location, and the like.

Further, the system 100 provides the capability for discovering or sharing the information via a plurality of potential channels, for example, one or more social networking sites. In one embodiment, the system 100 may process an employment opportunity enquiry at a certain location and aggregate a wide range of information items associated with the enquiry and the certain location. For example, address of a company with available open positions, compensation information of the company, other nearby potential employment opportunities, nearby housing information, map data (including public transportation, routes to job via car, walking, public transportation), neighborhood demographics, nearby education system, and other relevant information which may assist the user in ascertaining conditions associated with the area and the potential employment opportunities. As discussed earlier, the information items included in an enquiry may need to be fetched from various sources and aggregated before the information is presented to the user. In various embodiments, an application function, for example “Jobs Near Me,” may be implemented in one or more applications on a device, for instance, in a mapping application, in an Internet browser application, as a stand-alone application, and the like. The system 100 may be implemented and utilized in any global marketplace as a scalable platform with capabilities to determine country/territory specific data sources and support for a plurality of languages specific to an area and/or to a user. Further, the system 100 may utilize various algorithms for tracking and learning from a user's behavior over a period of time and usage.

A content/service provider (provider) API provides data about available jobs in a particular region. A provider's API can be queried by job description for a particular region, for example (unneeded parameters removed):

http://api.exampleprovider.com/ads/apisearch?q=java&1=austin%2C+tx&latlong=1

As a response, the provider may return a set of jobs with job information as well as certain location information in terms of latitude and longitude. For example:

```
<?xml version=″1.0″ encoding=″UTF-8″ ?>
<response version=″2″>
  ...
  <results>
    <result>
      <jobtitle>Java Developer</jobtitle>
      <company>XYZ Corp.</company>
      <city>Austin</city>
      <state>TX</state>
      <country>US</country>
      <formattedLocation>Austin, TX</formattedLocation>
      <latitude>30.27127</latitude>
      <longitude>-97.74103</longitude>
      ...
    </result>
    ...
  </results>
</response>
```

However, the job location provided by the provider may not always be an accurate location of the job, but just signifies a region the job is in. Most commonly this may be the center of a city, for example the center of greater New York area where relying only on this information could map all jobs to one location and not disperse them to the actual location of the company where the job may be available.

In one scenario, to determine the quality of matching between machine processed job location and the actual “example provider” job posting on the Web page a test dataset is generated, wherein the dataset includes over one hundred jobs from the “example provider” which may were read and processed (mapped to a company and location) by a human.

```
  <job id=″3516122″>
    <location street=″500 South Buena Vista Street″ city=″Burbank″
postalCode=″91521″ contactPhone=″(818) 555-1000″ state=″CA″ country=″US″
latitude=″34.155879″ longitude=″-118.326199″ name=″The Funny Land
Company″ />
    <expectedWords>
      <word>The</word>
      <word>Funny</word>
      <word>Company</word>
      <word>Land</word>
      <word>Studios</word>
    </expectedWords>
  </job>
  <job id=″3792153″>
    <location street=″1444 South Alameda Street″ city=″Los Angeles″
postalCode=″90021″ contactPhone=″(800) 888-8377″ state=″CA″ country=″US″
latitude=″34.023978″ longitude=″-118.238759″ name=″BRAND-X″ />
    <location street=″6801 Hollywood Boulevard″ city=″Los Angeles″
postalCode=″90028″ contactPhone=″(323) 800-0061″ state=″CA″ country=″US″
latitude=″34.101962″ longitude=″-118.340441″ name=″ BRAND-X″ />
    <location street=″8522 Beverly Boulevard″ city=″Los Angeles″
postalCode=″90048″ contactPhone=″(310) 600-5356″ state=″CA″ country=″US″
latitude=″34.075803″ longitude=″-118.377821″ name=″ BRAND-X″ />
    <location street=″5675 Telegraph Road″ city=″Commerce″
postalCode=″90040″ contactPhone=″(323) 700-8229″ state=″CA″ country=″US″
latitude=″34.004929″ longitude=″-118.15292″ name=″ BRAND-X″ />
    <location street=″K70, 189 The Grove Drive″ city=″Los Angeles″
postalCode=″90036″ contactPhone=″(323) 900-0949″ state=″CA″ country=″US″
latitude=″34.071609″ longitude=″-118.357093″ name=″ BRAND-X″ />
    <expectedWords>
      <word> BRAND-X</word>
      <word> BRAND-X</word>
      <word>inc</word>
      <word>Corporate</word>
      <word>Office</word>
    </expectedWords>
  </job>
```

The human created dataset includes companies that have one as well as multiple possible addresses. This dataset is then compared with different algorithms and different services (POI APIs) that provide information about business locations.

The POI API is a service that allows querying for a business by name (and possibly a general location, for example “greater New York area”) and as a result of the query returns location information for that business (if found).

Some test cases were performed over the POI API (various content/service providers) set to identify one or more accurate services to use for assigning an exact location to a company in a geographic area. An example of this is shown in Example 140 of FIG. 1B.

By analyzing the results it is shown that one POI API service will not be able to provide results that are good enough for our purpose. Also, a pattern is identified where one provider provided better results for big companies while others provided better results for small companies, while some provided a result it was buried in a large set of noise data thus making it difficult for extraction. Some providers didn't reflect adequate results for businesses at all as shown in Example 160 of FIG. 1C.

Next several (e.g., two or three) result sets provided by two or three different POI API services were aggregated, which proved to be most accurate results that may be used as a baseline for developing potential algorithms for mapping jobs to exact locations.

In one embodiment, the algorithm may first normalize the company name which may be received from a provider where normalization is a process that may remove elements of a company name that can be spelled different, shortened, etc. For example normalization of “Phone Inc.” may be normalized to “Phone.”

Example of entities that may be considered for normalization may include:

```
static readonly string[ ] businessEntities = new string[ ]
  {
    ″Corp″,
    ″Corporate″,
    ″Corporation″,
    ″Incorporated,″
    ″International″,
    ″Inc″,
    ″ltd″,
    ″dba″,
    ″Co″,
    ″Company″,
    ″SpA″,
    ″LLC″,
    ″LC″,
    ″LLLP″,
    ″LLP″,
    ″LP″,
    ″PLLC″,
    ″PLC″,
    ″PC″,
    ″Group″,
    ″PubG″,
    ″Publishing Group″
      ...
  };
```

In one embodiment, the normalized name may be used in a company search request to the POI APIs that may be available for use where multiple company names may be retrieved from multiple POI APIs (for example, a financial institution, a directory provider, etc.) Further, the company names found from all the datasets from POI APIs may be normalized. A next step in the process may be to clean up the datasets from POI APIs where the process may iterate through the POI API datasets and removes all results where the number of normalized words may not be the same.

In one embodiment, the matching process may then identify companies that have same words regardless of the order. For example, a successful match may be “Phone Hardware Networks” and “Phone Networks Hardware” where a non-match may be “Phone Hardware” and “Phone.” Further, the matching process may try to match acronyms (first letter of every word in the company name.) For example, if one searched for “Insurance International Group” and the POI API dataset contains “IIG” then the match would be successful as well. Furthermore, this process may also be performed in the reverse direction so if one searched for “IIG” a successful match may be “Insurance International Group.” Moreover, next the POI API datasets may be merged into one and then sorted by using one or more algorithms, for example, a typical or a Modified Levenstein Distance algorithm. The first item in a sorted list may be automatically selected as the match and the next few may be an option for alternative linking through a user collection.

The typical Levenstein Distance algorithm calculates how many operations are required to make two strings identical. Distance is a sum of all operations that are required to make two strings identical where every operation (insert, delete, replace) has its own weight. In the original algorithm every operation's weight is set to 1.

In one embodiment, a Modified Levenstein Distance algorithm may provide additional functionality and accuracy where the weight an operation has. In general, the Modified Levenstein Distance implements the following principles by having the weights adjusted: changing a symbol is cheaper than a word. For example, deleting a “.” is a lot cheaper than deleting any letter (e.g. “a”) and replacement is more expensive than deletion or an insert. For example, in searching for “Phone,” the algorithm prefers “Phone Corp” over “Fhone” because of the modification. The weights may be adjusted logically and empirically by running different weight setups on the same test dataset. In various implementations, performance of the Modified Levenstein Distance and Levenstein Distance are substantially the same with no additional processing time required for algorithm implementation where implementing the modified algorithm may significantly improve the test results.

As shown in FIG. 1, in one embodiment, the system 100 includes user equipment (UE) 101a-101n (also collectively referred to as a UE 101 and/or UEs 101), which may be utilized to execute one or more applications 103a-103n (also collectively referred to as applications 103) including navigation application, jobs near me, games, social networking, web browser, media application, user interface (UI), map application, web client, etc. to communicate with other UEs 101, one or more service providers 105a-105n (also collectively referred to as service provider 105), one or more content providers 107a-107n (also collectively referred to as content providers 107), a processing platform 109, one or more satellites 111a-111n (also collectively referred to as the satellites 111), and/or with other components of a communication network 113 directly and/or over the communication network 113. In one embodiment, the UEs 101 may include data collection modules 115a-115n (also collectively referred to as DC module 115) for determining and/or collecting data associated with the UEs 101, one or more sensors of the UE 101, one or more users of the UEs 101, applications 103, one or more content items, and the like.

In one embodiment, the service providers 105 may include and/or have access to one or more databases 117a-117n (also collectively referred to as database 117), which may include various mapping data, user information, user profiles, user preferences, one or more profiles of one or more user devices (e.g., device configuration, sensors information, etc.), service providers 105 information, other service providers' information, and the like. In one embodiment, the service providers 105 may include one or more service providers offering one or more services, for example, navigation services, location based services, online shopping, social networking services (e.g., blogging), content sharing, media upload, media download, media streaming, account management services, or a combination thereof. Further, the service providers 105 may conduct a search for content items, media items, information, coupons, and the like associated with one or more users, POIs, geo-locations, and the like.

In one embodiment, the content providers 107 may include and/or have access to one or more database 119a-119n (also collectively referred to as database 119), which may store, include, and/or have access to various content items. For example, the content providers 107 may store content items (e.g., at the database 119) provided by various users, various service providers, crowd-sourced content, and the like. Further, the service providers 105 and/or the content providers 107 may utilize one or more service application programming interfaces (APIs)/integrated interface, through which communication, media, content, and information (e.g., associated with users, applications, services, content, etc.) may be shared, accessed and/or processed. In various embodiments, the content providers 107 may include one or more public, private, governmental, free access, access for a fee, and the like entities, which may provide information on individuals, companies, geo-locations, POIs, and the like.

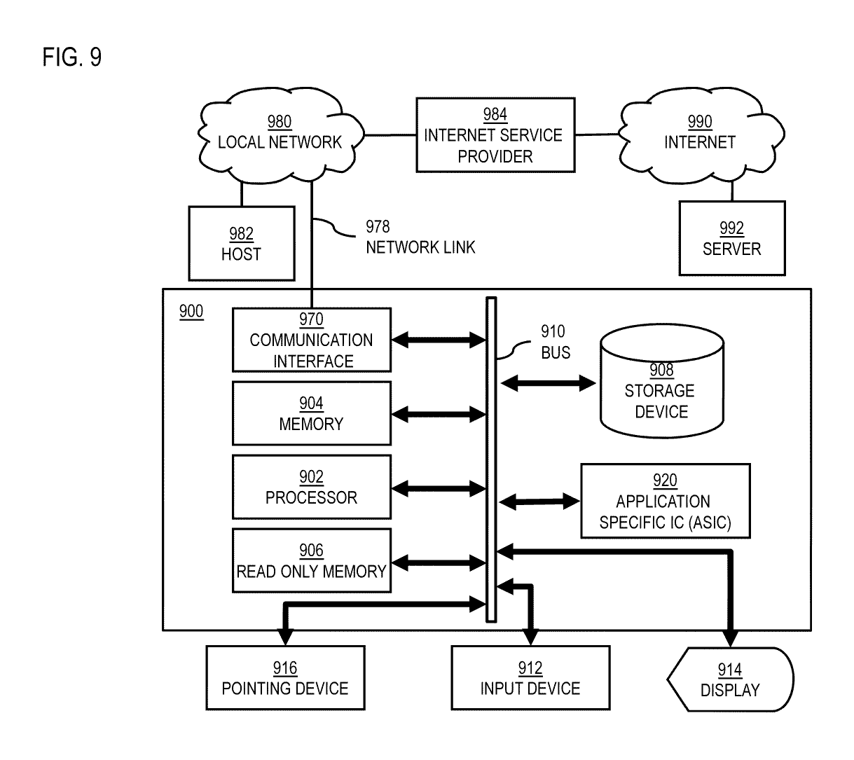

In one embodiment, the processing platform 109 may include and/or have access to one or more database 121a-121n (also collectively referred to as database 121), which may store, include, and/or have access to various data, for example, from different sources and/or different time periods associated with location information, user information, device information, points of interest (POIs), service provider information, and the like. Further, the processing platform 109 may include various processing platforms utilizing various processing mechanisms, for example, direct processing, distributed processing (e.g., server farms), and the like. Furthermore, the processing platform 109 and/or the database 121 may be partially or completely implemented within one or more service providers, one or more modules, one or more architectures, and the like. In one embodiment, the processing platform 109 is a computer system as described with respect to the FIG. 9 below.

In various embodiments, the processing platform 109 may sort, manage, store, and/or make the data available based on various parameters, for example, location information (e.g., of a user, of a service provider, of a content provider, of a requestor, etc.), sequential order, data type, date/time of data creation and/or submission, date/time of a data request, and the like. In various embodiments, the processing platform 109 may be maintained on a network server, while operating in connection with the service providers 105 and/or the content providers 107 as an extensible feature, a web-service, an applet, a script, an object-oriented application, or the like to enable searching for and/or processing of the social networking information. Further, the processing platform 109, the service providers 105, and/or the content providers 107 may utilize one or more service application programming interfaces (APIs)/integrated interface, through which communication messages, data, content, and the like may be exchanged, shared, accessed, and/or processed.

In one embodiment, the UE 101 includes a location module/sensor that can determine the UE 101 location (e.g., a user's location). The UE 101 location can be determined by a triangulation system such as a GPS, assisted GPS (A-GPS), Cell of Origin, wireless local area network triangulation, or other location extrapolation technologies. Standard GPS and A-GPS systems can use the one or more satellites 111 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., WLAN) connection to determine the UE 101 location information, for example, from an Internet source (e.g., a service provider).

In one embodiment, the system 100 may determine location information associated with the one or more proximate POIs (e.g., an office building, a shop, etc.) depicted in a virtual environment using one or more location-based technologies associated with a UE 101 (e.g., global positioning system (GPS) receivers, cellular triangulation, assisted-GPS (A-GPS), etc.). It is also contemplated that the one or more AR applications used to render the virtual environment may already contain the geo-coordinates for the one or more POIs.

In one embodiment, the processing platform 109 may process and/or facilitate a processing of location information, contextual information, or a combination thereof associated with at least one user to determine one or more parameters for causing an aggregation of information across a plurality of data sources. In one embodiment, the processing platform 109 may receive and process an enquiry from a user for information associated with one or more POIs, where location of the user is a parameter of the enquiry. Further, the enquiry may include contextual information to identify one or more subjects, one or more topics, and the like for the enquiry. In one embodiment, the contextual information may include information on geo-location of a user or a POI, social networking, historic data, personal profile, and the like. In one embodiment, the processing platform 109 may utilize one or more parameters from the enquiry to request one or more information items from one or more sources. In one embodiment, the processing platform 109 may determine one or more sources that may be capable of providing the requested information. In one embodiment, the processing platform 109 may determine the requested information from a data store available to the processing platform 109.

In one embodiment, the processing platform 109 may cause, at least in part, an initiation of the aggregation of the information based, at least in part, on the one or more parameters. In one embodiment, the processing platform 109 may aggregate a plurality of information items against one or more parameters determined from the request from a user. In one use case scenario a request from a user may indicate a location, a subject matter, one or more topics of interest, and the like. In one example, a user may request information related to an employment position at a certain company and at a certain location where the processing platform 109 may perform a search across a plurality of content/information providers. For example, various information items associated with an employment position may be available via a plurality of sources or databases, for instance, a salary database, a company information database, etc. Further, the processing platform 109 may request various information items associated with location of the employment position, for example, housing information, commute information, school information, cost of living information, and the like. In one embodiment, the processing platform 109 may aggregate the various information items from the various sources based, at least in part, on one or more parameters determined from a user enquiry.

In one embodiment, the processing platform 109 may cause, at least in part, a presentation of the aggregation of the information in an augmented reality user interface, wherein the aggregation of the information includes, at least in part, location-based content. In one embodiment, the processing platform 109 may determine additional information associated with the user environment, for example, location of the user, POIs near the user location, and the like. Further, the processing platform 109 may determine one or more parameters for causing a presentation of the aggregated information as an AR presentation at the user device.

In one embodiment, the processing platform 109 may process and/or facilitate a processing of the location information, contextual information, or a combination thereof to determine social networking information associated with the at least one user, wherein the aggregation of the information is further based, at least in part, on the social networking information. In one embodiment, the processing platform 109 may determine one or more social networking links associated with a user requesting one or more information items, wherein the social networking information may be utilized in aggregating the information items for the user. In one embodiment, the user location may be included in the parameters for aggregating the information for the user.

In one embodiment, the processing platform 109 may process and/or facilitate a processing of the social networking information to determine one or more contacts related to the at least one user that are associated with the aggregation of the information. In one embodiment, the processing platform 109 may determine and process one or more social networking information associated with a user and a user request for determining one or more social networking contacts for aggregating one or more information items available from one or more sources. In one embodiment, the user may be associated with one or more social networking sites wherein one or more contacts may be associated with one or more information items available for the aggregation of a plurality of information items for the user.

In one embodiment, the processing platform 109 may determine personal profile information for the at least one user, wherein the aggregation of the information is further based, at least in part, on the personal profile information. In one embodiment, the processing platform 109 may determine one or more user personal profile from a user device, a user social networking account, from one or more user profiles via one or more contacts, and the like, which may be utilized in aggregating one or more information items for the user. For example, a user account at a social networking site may indicate information on the user's education, employment history, geo-location preferences, and the like.

In one embodiment, the processing platform 109 may cause, at least in part, a storage of at least a portion the aggregation of the information based, at least in part, on one or more user interactions with the augmented reality interface. In one embodiment, the processing platform 109 may cause storage of one or more portions of an enquiry and/or information items at one or more local and/or remote storage devices, for example a cloud based storage, so that the user and/or the processing platform 109 may access the stored data.

In one embodiment, the processing platform 109 may cause, at least in part, a compilation of user information related to the aggregation of the information. In one embodiment, the processing platform 109 may filter and/or further process the one or more information items in order to compile the one or more information items, which may be received/accessed from one or more sources (e.g., content providers.) For example, the processing platform 109 may have received a plurality of information items from various sources where the information items may be further processed and compiled into an aggregation for the user. In one embodiment, the aggregation of the information relates, at least in part, to one or more postings, and wherein the compilation relates, at least in part, to one or more applications for the one or more postings. In one embodiment, the posting may include information associated with an employment opportunity. In one embodiment, the posting may include information associated with educational opportunities (e.g., for students) at an educational institution. In one embodiment, the posting may include information associated with an internship position. In one embodiment, the aggregation of the information relates, at least in part, to one or more organizations, one or more geographic areas, demographic information, or a combination thereof associated with the one or more postings.

In one embodiment, the processing platform 109 may cause, at least in part, a recommendation of at least a portion of the aggregation of the information based, at least in part, on the location information, the contextual information, the one or more parameters, user profile information or a combination thereof. In one embodiment, the processing platform 109 may analyze one or more information items in the aggregated information in order to provide a recommendation to the user, for example an employment position, from a plurality of possible options. In various embodiments, the recommendation may be based, at least in part, one a geo-location, on user preferences, user profile, user history, employment history, education history, and the like.

In one embodiment, the processing platform 109 may cause, at least in part, a storage of the one or more parameters, the aggregation of the information, the location information, the contextual information, or a combination thereof as historical information for the at least one user, as reusable information for one or more other users, or a combination thereof. In one embodiment, the processing platform 109 may store/save one or more portions of the aggregated information and/or one or more information items associated with one or more portions of the aggregated information at a storage device (e.g., local, cloud storage, etc.) In one embodiment, one or more users may access the stored information which may be associated with one or more other users. In one embodiment, the processing platform 109 may access and/or process the stored data for presentation to one or more users at a later time.

By way of example, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the applications 103, the service providers 105, the content providers 107, the processing platform 109, and the satellites 111 communicate with each other and other components of the communication network 113 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

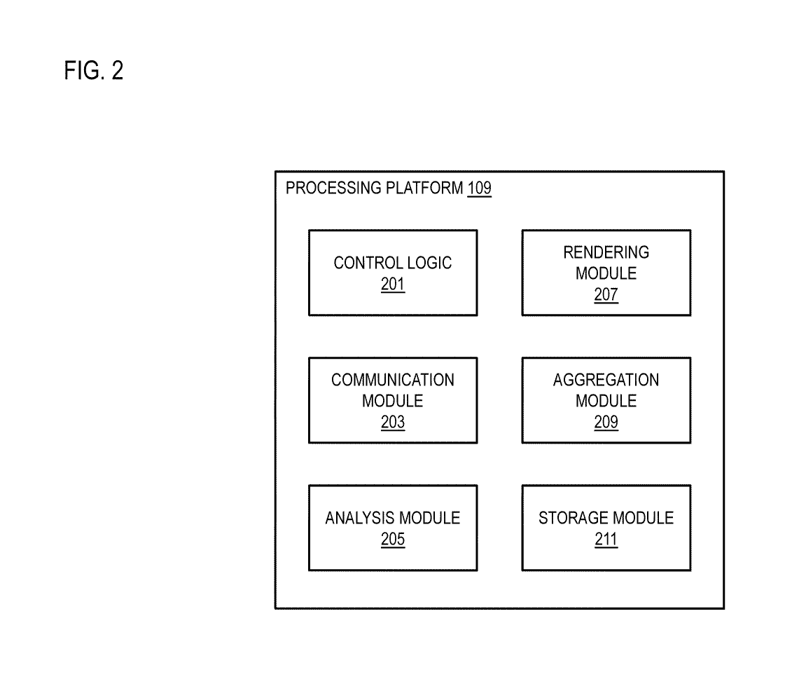

FIG. 2 is a diagram of the components of a processing platform 109, according to an embodiment. By way of example, the processing platform 109 includes one or more components for aggregating information and causing a presentation of the information in AR at a user device. It is contemplated that the functions of these components may be combined in one or more components or performed by other components of equivalent functionality. In this embodiment, the processing platform 109 includes a control logic 201, a communication module 203, an analysis module 205, a rendering module 207, an aggregation module 209, and a storage module 211.

The control logic 201 oversees tasks, including tasks performed by the communication module 203, the analysis module 205, the rendering module 207, the aggregation module 209, and the storage module 211. For example, although the other modules may perform the actual task, the control logic 201 may determine when and how those tasks are performed or otherwise direct the other modules to perform the task. The control logic 201 may be implemented in various embodiments, for example, as one or more of various processors, coprocessors, microprocessors, controllers, digital signal processors (DSP), and the like.

The communication module 203 is used for communication between the UE 101, the processing platform 109, the services providers 105, the content providers 107, and the satellites 111. The communication module 203 may also be used to determine location information (e.g., geo-coordinates) associated with the one or more, users and POIs in the real-world environment. The communication module 203, in connection with the storage module 211, also may be used to associate the location information with the one or more users, recommendations, and the POIs.

The analysis module 205 may receive position information indicative of the current location (or position) of a UE 101 (e.g., from a positioning sensor) or a current location (or position) of real world objects currently being shown by a camera view of the UE 101. The analysis module 205 may also receive orientation information indicative of an orientation of the UE 101 with respect to the current location. For example, the analysis module 205 may receive orientation information indicative or descriptive of the orientation of the UE 101 (relative to a reference) so that a field of view that the UE 101 would be expected to have at the current location may be determined based on the current location and the orientation information.

As previously discussed, the rendering module 207 is used to cause rendering of a UI depicting a virtual environment comprising one or more notifications associated with one or more points of interest. More specifically, the rendering module 207, in connection with the communication module 203, may also be used to render the AR in the UI of the UE 101 based, at least in part, on the location information associated with the one or more points of interest in the real-world environment. The rendering module 207 also may be used to render one or more information tags, the metadata, the location information, or a combination thereof based, at least in part, on one or more lists, one or more maps, or a combination thereof, wherein the one or more maps are based, at least in part, on the location information. The rendering module 207 may then retrieve (or request) augmented/virtual reality information (also referred to herein as AR information) from an AR repository storage that correlates to both the current location and the orientation information. As referred to herein, the AR information (also referred to herein interchangeably as virtual information) may include, but is not limited to geo-coded information corresponding to location information (e.g., longitude, latitude and/or altitude coordinates) of real world objects (e.g., building, landmarks, etc.) and may include one or more information layers. The real world objects may be associated with objects in a current location of the UE 101 shown in a camera view of the camera module or display of the UE 101. The information layers may be associated with one or more virtual objects (e.g., icons, pictograms, images, or the like).

The aggregation module 209 may request and receive various information items from various content providers. In one instance, the information items may be related to an employment position available at a certain company, wherein the related information items may be associated with a geo-location address of the company, nearby housing information, company information, salary information, company history, and the like. However, as the various information items may be received from a plurality of sources, the aggregation module 209 may filter, analyze, and aggregate most relevant and updated information items for recommendation to the user at a UE 101. In one embodiment, the information items may include metadata which may be utilized to configure a presentation in AR at the UE 101.

The storage module 211, in connection with the user analysis module 205, is used to manage the storage of the one or more information items, metadata, one or more images, one or more videos, the location information, or a combination thereof associated with a user and/or one or more POIs at a local storage device, at one or more remote servers (e.g., based on cloud storage technologies), or a combination thereof. By way of example, the storage module 211 may determine to store one or more information items for a predetermined time, or until additional space is required at the storage device, or until updated versions of the information items become available, or a combination thereof.

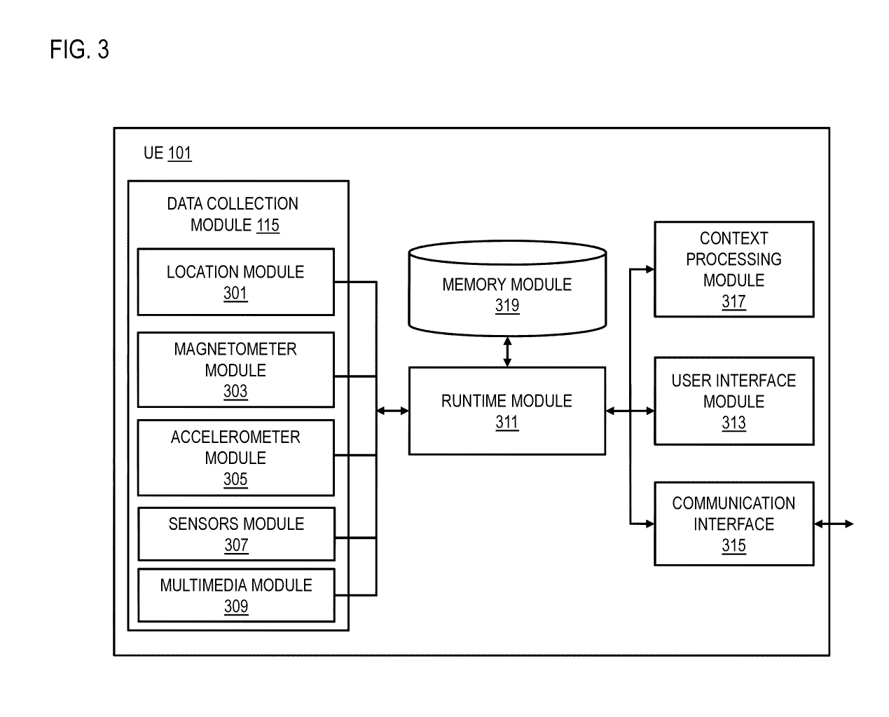

FIG. 3 is a diagram of the components of a user equipment capable of implementing one or more component for presenting content in augmented reality, according to an embodiment. By way of example, a UE 101 includes one or more components for communication with a processing platform and presenting information in AR, VR, and/or MR environments. It is contemplated that the functions of these components may be combined in one or more components or performed by other components of equivalent functionality. In this embodiment, the UE 101 includes a DC module 115 that may include one or more location modules 301, magnetometer modules 303, accelerometer modules 305, sensors module 307, and multimedia module 309. Further, the UE 101 may also include a runtime module 311 to coordinate the use of other components of the UE 101, a user interface module 313, a communication interface 315, a context processing module 317, and a memory module 319. The applications 103 of the UE 101 can execute on the runtime module 311 utilizing the components of the UE 101.

The location module 301 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 111 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 301 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory module 319 and are available to the context processing module 317, the DC module 115, the service providers 105, and/or to other entities of the system 100 (e.g., via the communication interface 315.) Moreover, in certain embodiments, the GPS coordinates can include an altitude to provide a height. In other embodiments, the altitude can be determined using another type of altimeter. In certain embodiments, the location module 301 can be a means for determining a location of the UE 101, an image, or may be used to associate an object in view with a location.

The magnetometer module 303 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory module 319, made available to other modules and/or applications 103 of the UE 101, and/or transmitted via the communication interface 315 to one or more entities of the system 100.

The accelerometer module 305 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 305 can determine the angle the UE 101 is pointed as compared to Earth's gravity. In certain embodiments, the magnetometer module 303 and accelerometer module 305 can be means for ascertaining a perspective of a user. This perspective information may be stored in the memory module 319, made available to other modules and/or applications 103 of the UE 101, and/or sent to one or more entities of the system 100.

In various embodiments, the sensors module 307 can process sensor data from various sensors (e.g., GPS, accelerometer, gyroscope, thermometer, etc.) to determine environmental (e.g., atmospheric) conditions surrounding the UE 101, user mood (e.g., hungry, angry, tired, etc.), location information, and various other information from a range of sensors that may be available on a UE 101. For example, the sensors module 307 may detect conditions including humidity, temperature, geo-location, biometric data of the user, etc. Once again, this information can be stored in the memory module 319 and sent to the context processing module 317 and/or to other entities of the system 100. In certain embodiments, information collected from the DC collection module 115 can be retrieved by the runtime module 311 and stored in memory module 319, made available to other modules and/or applications 103 of the UE 101, and/or sent to one or more entities of the system 100.

In one embodiment, the multimedia module 309 may be utilized to capture various media items, for example, images, video, audio, and the like, wherein the captured media may be submitted to one or more modules and applications of the UE 101, a service provider, and/or a content provider for further processing, storage, sharing, and the like. For example, a captured image of a POI (e.g., a building) may be submitted to the processing platform 109, a service provider 105, and/or the context processing module 317 for analysis and correlation to one or more information items (e.g., contact information, employment positions, etc.) associated with a current location and the captured image.

The UI module 313 may include various methods of communication. For example, the UI module 313 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc. In one embodiment, the UI module 313 is capable of presenting information items in an AR, VR, and/or MR environments. Further, the UI module 313 may receive augmented/virtual reality information from an AR repository storage and/or the processing platform 109 that correlates to both the current location and the orientation information. The AR information may include, but is not limited to geo-coded information corresponding to location information (e.g., longitude, latitude and/or altitude coordinates) of real world objects (e.g., building, landmarks, etc.) and may include one or more information layers. The real world objects may be associated with objects in a current location of the UE 101 shown in a camera view of the camera module or display of the UE 101. The information layers may be associated with one or more virtual objects (e.g., icons, pictograms, images, or the like).

In one embodiment, the communication interface 315 can be used to communicate with one or more entities of the system 100. Certain communications can be via methods such as an internet protocol, messaging (e.g., SMS, MMS, etc.), or any other communication method (e.g., via the communication network 113). In some examples, the UE 101 can send context information associated with the UE 101 to the service providers 105, content providers 107, the processing platform 109, and/or to other entities of the system 100.

The context processing module 317 may be utilized in determining context information from the DC module 115 and/or the applications 103 executing on the runtime module 311. This information may be caused to be transmitted, via the communication interface 315, to the processing platform 109 and/or to other entities of the system 100. The context processing module 317 may additionally be utilized for determining information related to the user, an instance of data, content/information search requests, a content item, an object, a subject, and the like. In certain embodiments, the context processing module 317 can infer higher level context information from the context data such as favorite locations, significant places, common activities, interests in products and services, POIs at various geo-locations, etc.

In various embodiments, the runtime module may cause one or more modules/components of a UE 101 to associate one or more available data items with one or more content items available from the one or more modules/components of the UE 101. For example, date, time, location, and user information associated with a device at a particular time may be associated (e.g., as metadata) with an image that is captured by the UE 101 at that particular time.

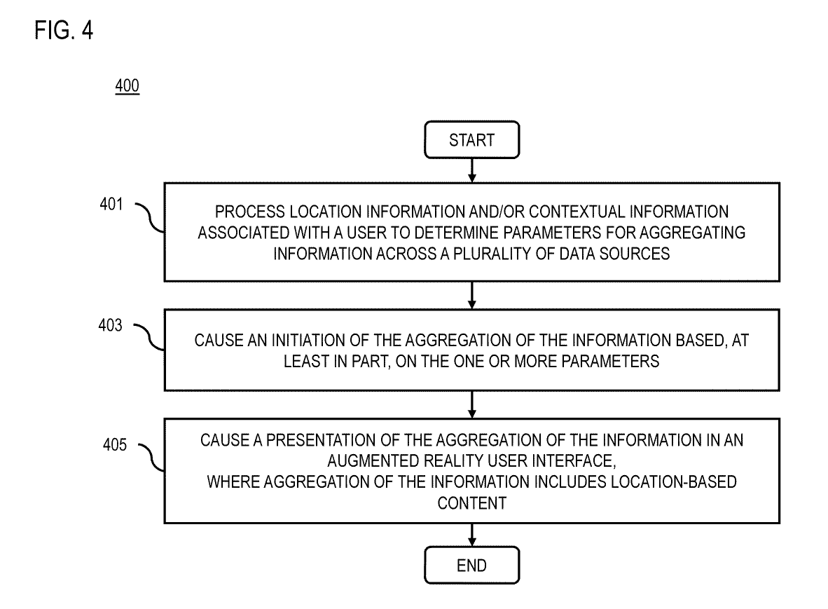

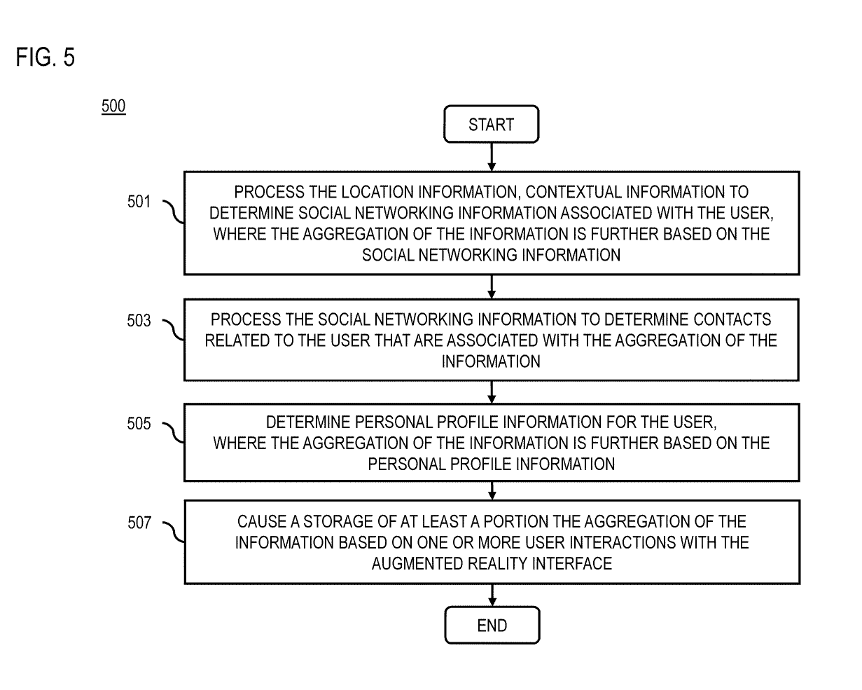

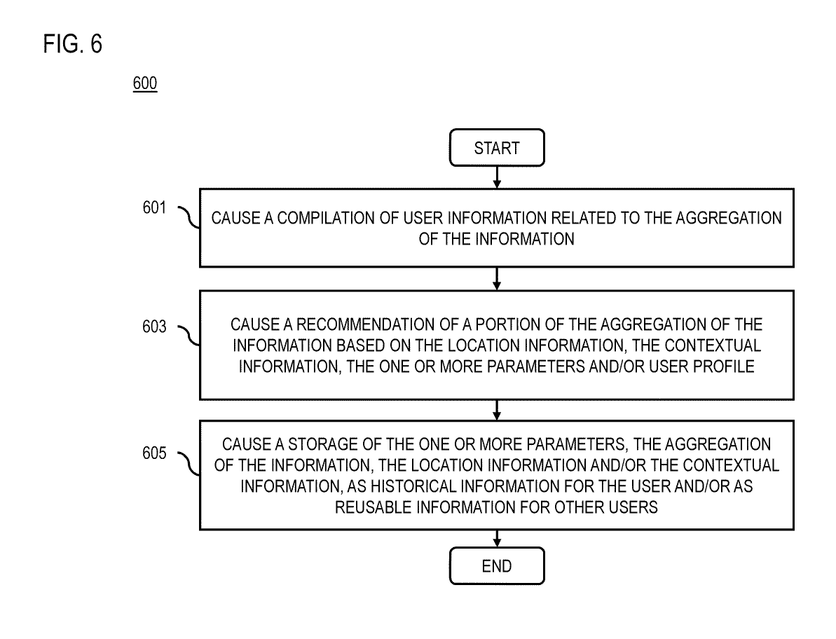

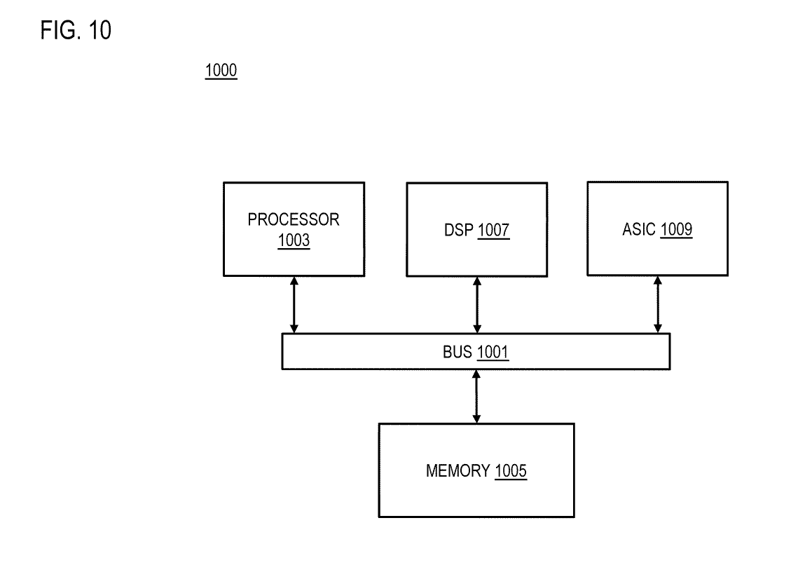

FIGS. 4 through 6 illustrate flowcharts of various processes for, at least, processing and presenting aggregated information to a user via an augmented reality user interface, according to various embodiments. In various embodiments, the applications 103, the DC module 115, and/or the processing platform 109 may perform one or more portions of the processes 400, 500, and 600, which may be implemented in, for instance, a chip set including a processor and a memory as shown in FIG. 10. As such, the applications 103, the DC module 115, and/or the processing platform 109 can provide means for accomplishing various parts of the process 400, 500, and 600 as well as means for accomplishing other processes in conjunction with other components of the system 100. Throughout these processes, the applications 103, the DC module 115, and/or the processing platform 109 may be referred to as completing various portions of the processes 400, 500, and 600, however, it is understood that other components of the system 100 can perform some of and/or all of the process steps. Further, for clarity in discussing the 400, 500, and 600, the processing platform 109 is referred to as completing various steps of the processes.

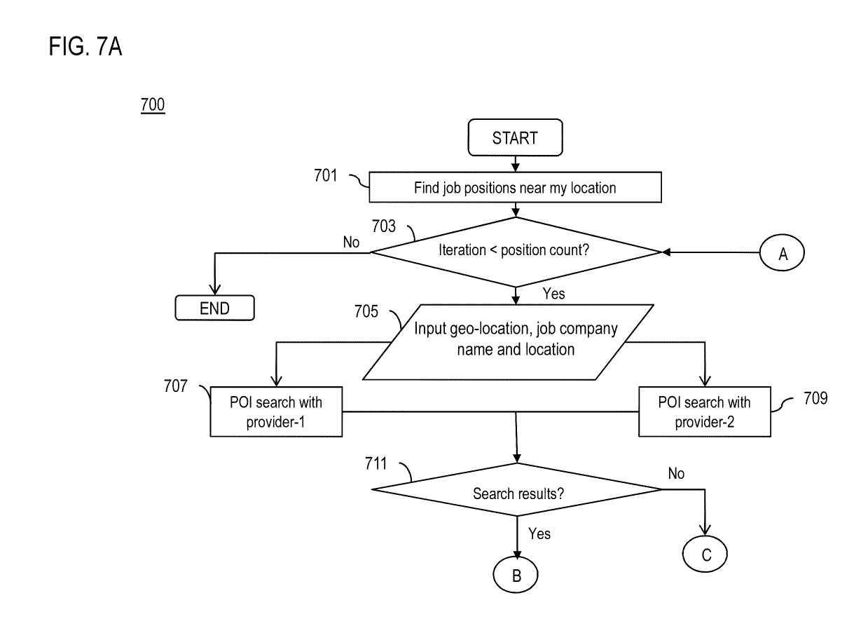

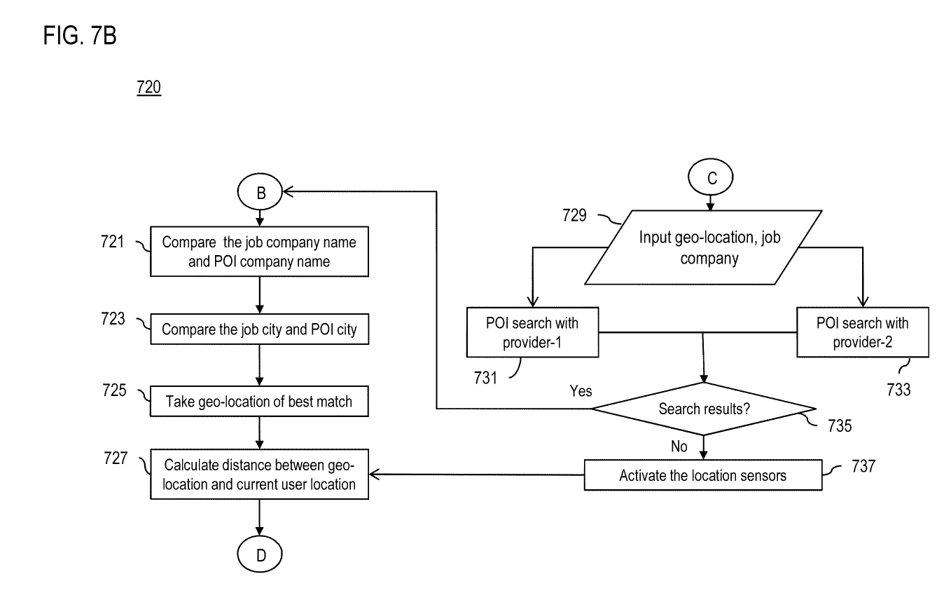

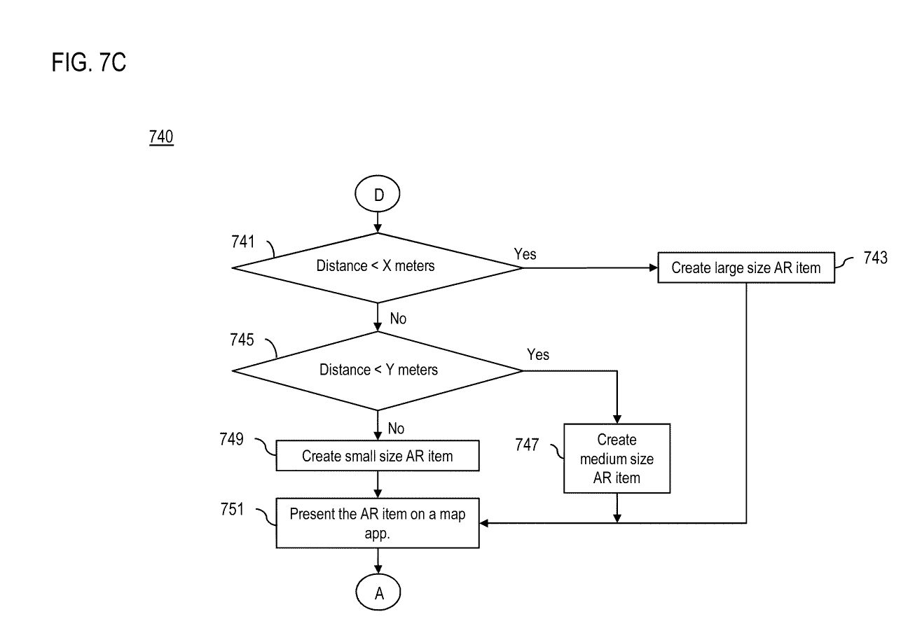

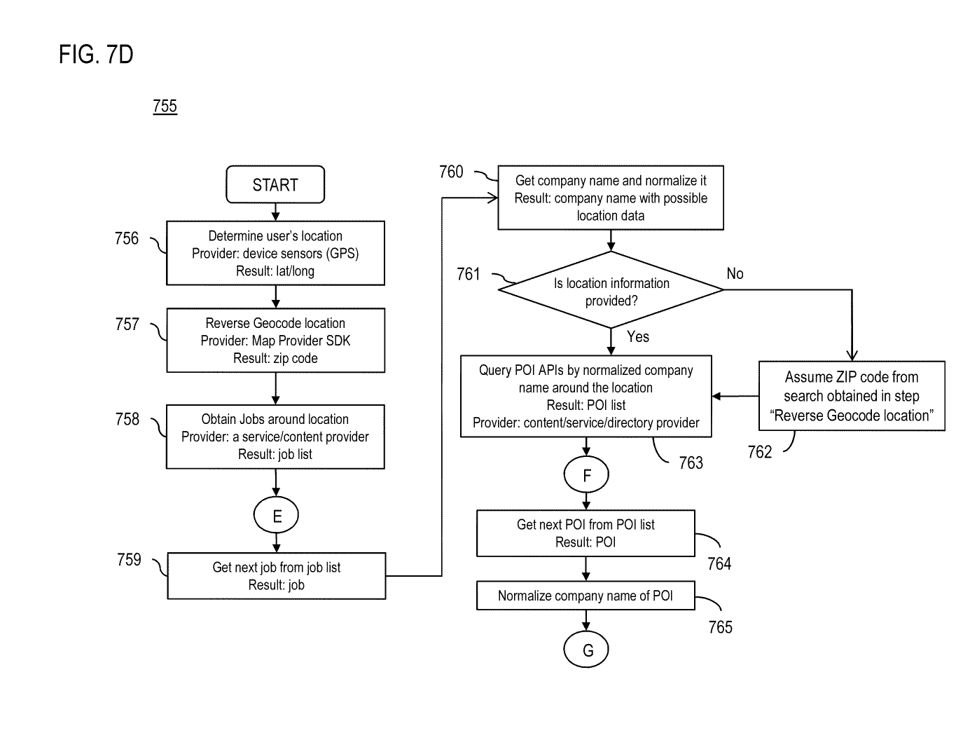

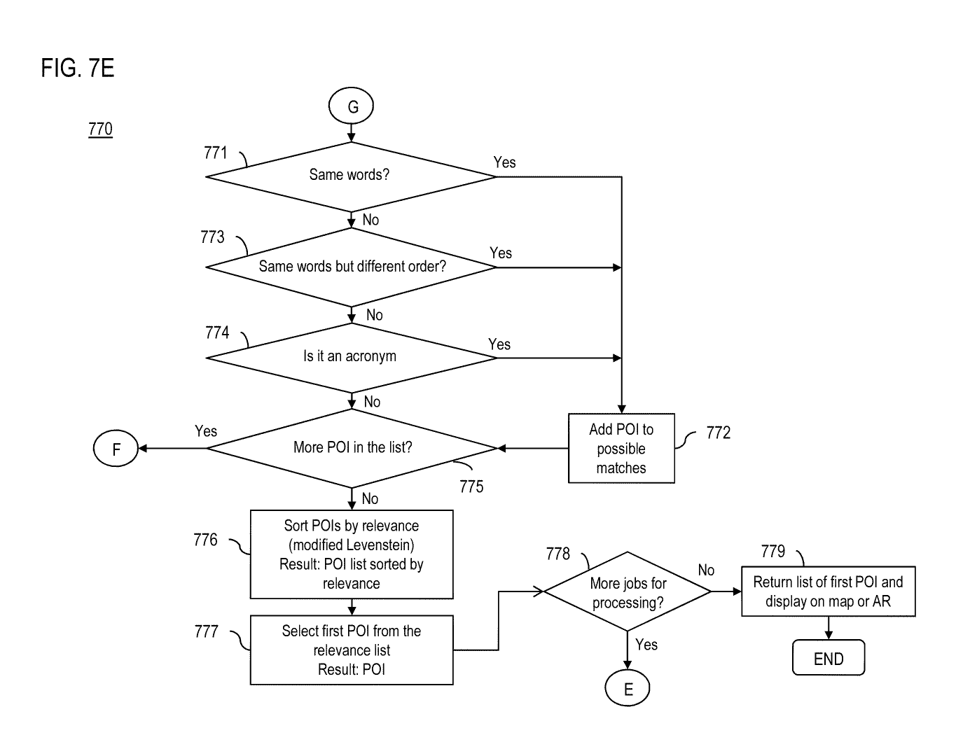

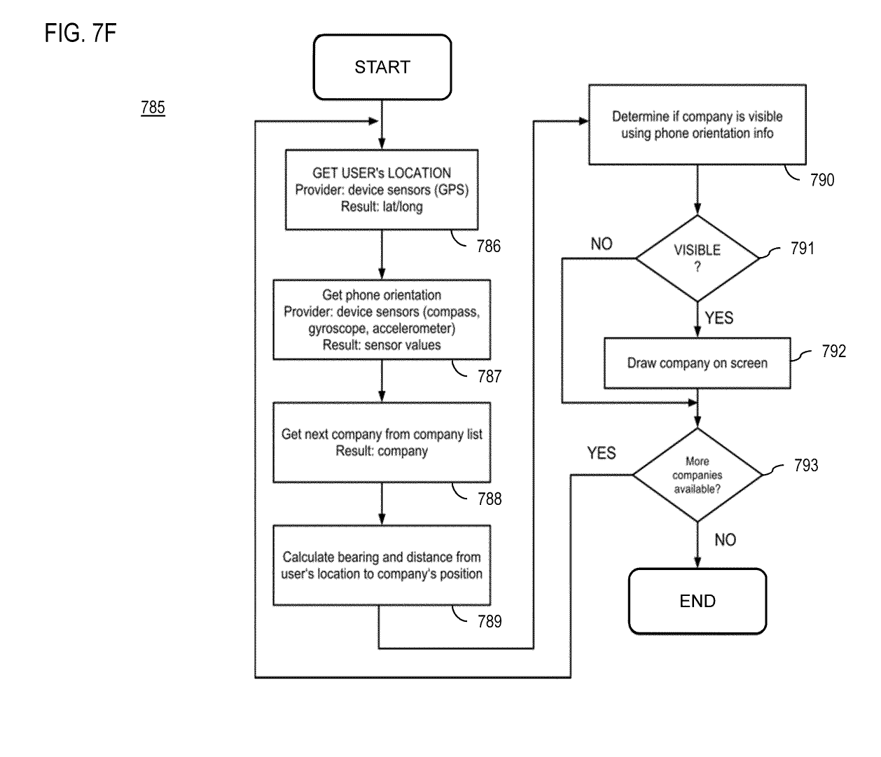

FIGS. 7A through 7F illustrate flowcharts of a process for aggregating information associated with one or more job positions, according to various embodiments.

In FIG. 7A, in step 701 of the process 700 the processing platform 109 may receive a request from a user for information on one or more job positions (positions) which may be available near the user location, wherein the location information may be determined from a user device. In step 703, the processing platform 109 may determine the number of available employment positions and determine whether to further execute the process 700. If there are no positions to evaluate, then the process 700 ends, otherwise the process proceeds to step 705 where one or more information items; for example, company geo-location, company name, user location, and the like, may be determined from a source listing the position and related information, which may then be checked against information items available from various content providers to ascertain validity of the information and/or to obtain additional related information. For example, a provider-1 may provide an address location of a company and a provider-2 may provide job information for the company. In step 711, the processing platform 109 may determine whether there search results and whether they are valid, current, complete, and the like; if there are search results, then the process proceeds to step B of process 720 in FIG. 7B, otherwise the process proceeds to step C of the process 720 in FIG. 7B.

In FIG. 7B, the process from the FIG. 7A may continue in step B of the process 720, where in step 721 the processing platform 109 may compare the company name that is presenting the job position and a company name that may be determined from the search results by utilizing one or more algorithms, for example, by determining the Levenstein distance between the two names. In step 723 name of the city/town/state where the employment position is listed may be compared (e.g., Levenstein distance) to the user location (POI) to determine. In step 725 a best match is selected for the geo-location of the company location and the user location where in step 727 the physical distance between the two locations is determined, for example, for a map application. Alternatively, if there were no search results in step 711 of the process 700, then the process 720 may begin at step C, where in step 729 additional geo-location and job company information items may be determined and compared to a provider-1, 731 and a provider-2, 733. In step 735, if there are search results, then the process returns to step B for further analysis, otherwise, the process continues to step 737 where one or more location sensors on the UE 101 may be activated to determine the current location of the user.

In FIG. 7C, the process from the FIG. 7B may continue in step D of the process 740, where in step 741 the processing platform 109 may determine if the distance between the location of the job company and the user location is at less than, equal to, or greater than a first certain distance (e.g., X meters). In one instance if the distance is less than 536 meters, then the processing platform 109 may cause or suggest at 743 for the information item to be presented at a UE 101 as a large sized AR presentation item. Alternatively, in step 745, if the distance is less than, equal to, or greater than a second certain distance (e.g., Y meters), for example less than 1072 meters, then the processing platform 109 may cause or suggest at 747 for the information item to be presented at a UE 101 as a medium sized AR presentation item. However, if the distance is not less than the predetermined distance Y, then at step 749 a small sized AR presentation item may be caused to be created. In step 751, either of the small, medium, or large AR presentation items may be presented on a map application at the UE 101.

In FIG. 7D, in step 756 of the process 755 the processing platform 109 may determine a user's location information via one or more location sensors on a UE 101 where the location information may include geo-coordinates (e.g., GPS, latitude/longitude). In step 757 the location information may be utilized to determine a zip code, an area code, and the like where the information may be associated with a map application and a provider for the map application. In step 758 the location information may be utilized to search for one or more jobs near the location. In step 759 the processing platform 109 may fetch the next job listing from the one or more determined jobs. In step 760 the processing platform 109 may determine a company name associated with the one or more jobs and a potential location for each of the companies in the list. Further the company names are normalized, for example, a company name of “Phones Ltd.” may be normalized to “Phones.” In step 761 the collected information is analyzed to determine if there are location information associated with each company name where if there are no location information, then the process continues to step 762 where zip code determined in step 757 is utilized and the process continues to step 763 where one or more queries are submitted to one or more content/service/directory provider where a POI list is checked against information from the one or more providers. In step 764 the next POI from the POI list is obtained and it is normalized in step 765. The process 755 continues to process step G of process 770 of FIG. 7E.

In FIG. 7E, in step 771 the processing platform 109 may analyze the normalized names to determine if it is the same as the company name where if it is the same, then the process continues to step 772, otherwise, the process continues to step 773 where a further analysis is performed to determine if the words may be the same but in different order, if so, the process continues to step 772, otherwise it continues to step 774. In step 774 another analysis is performed to determine if the words in the company name are acronyms, if so, the process continues to step 772 where the POI is added to a list of possible matches, otherwise, the process continues to step 775 where the processing platform 109 may check to determine if there are additional POI in the list; if yes, then the process return to process step F; otherwise, the process continues to step 776 where the processing platform 109 may sort the POIs by relevance, for example, by utilizing one or more forms of the Levenstein algorithm. In step 777 the first POI from the relevance list may be selected. Further, is step 778 the processing platform 109 determines if there are additional jobs for processing; if so, the process returns to process step E, otherwise, the process continues to step 779 where a list of the first POI is returned and caused for AR display, for example, via a map application on the UE 101.

In FIG. 7F, in step 786 of the process 785 the processing platform 109 may determine a user's location via one or more location sensors on a UE 101, for example, via GPS data. Further, in step 787 orientation of the UE 101, for example a mobile device, is determined via one or more sensors on the UE 101, for example, a compass, a gyroscope, an accelerometer, and the like. In step 788 the next company name from the company list is obtained and in step 789, the bearing and distance from the user's location to the company location is determined. Further, in step 790 from the information from the UE 101 it is determined whether or not the company is visible. In step 791 if it determined that it is visible, then the process continues to step 792 where an AR presentation is rendered on the UE 101 and the process continues to step 793, however, if in step 791 it determined that the company is not visible, then the process continues to step 793. In step 793 the processing platform 109 determines if there are additional companies available on the list, if so, then the process returns to step 786, otherwise, the process ends.

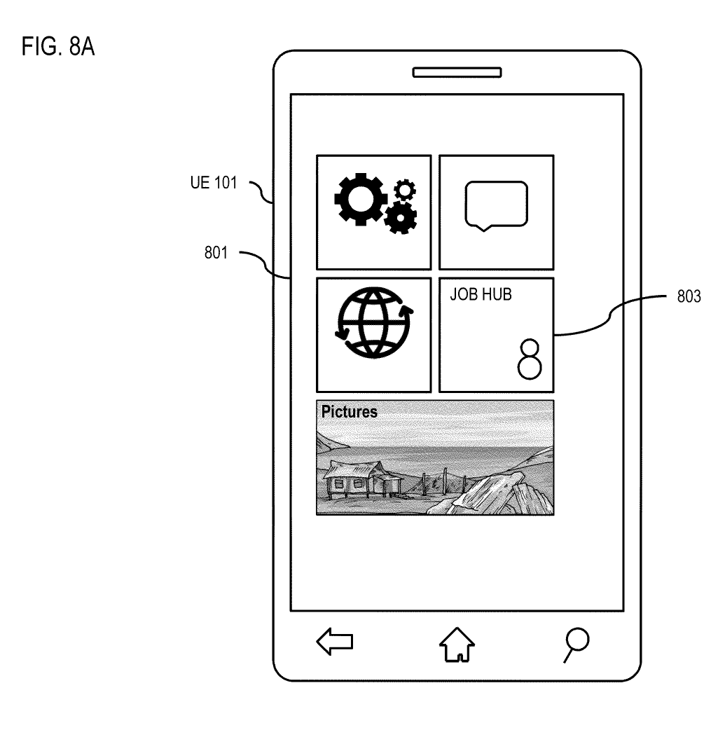

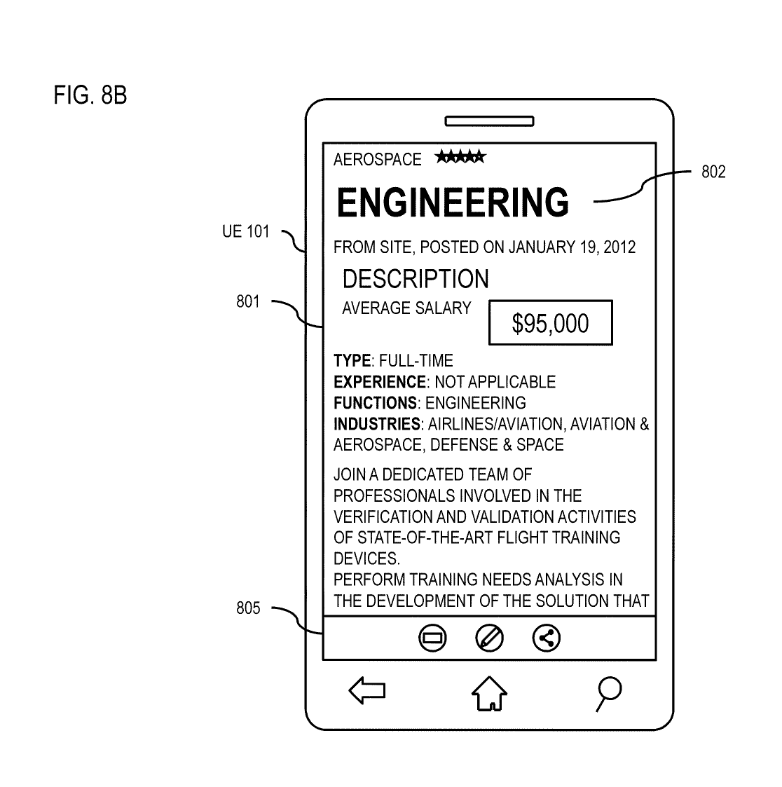

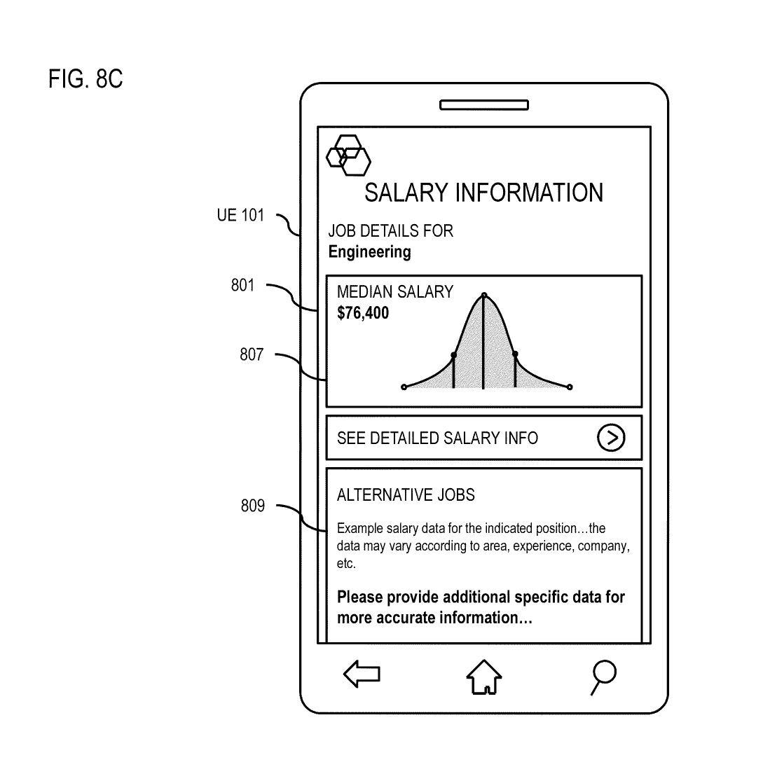

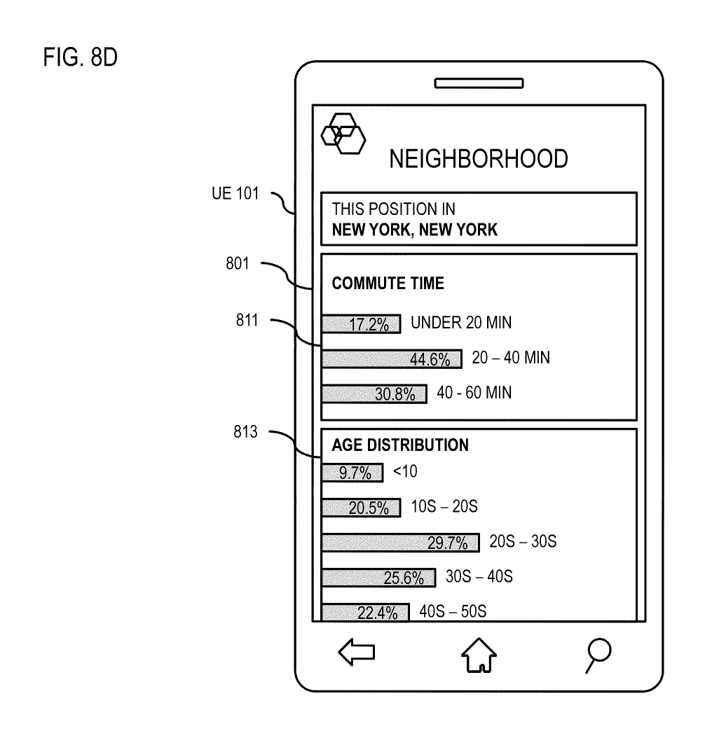

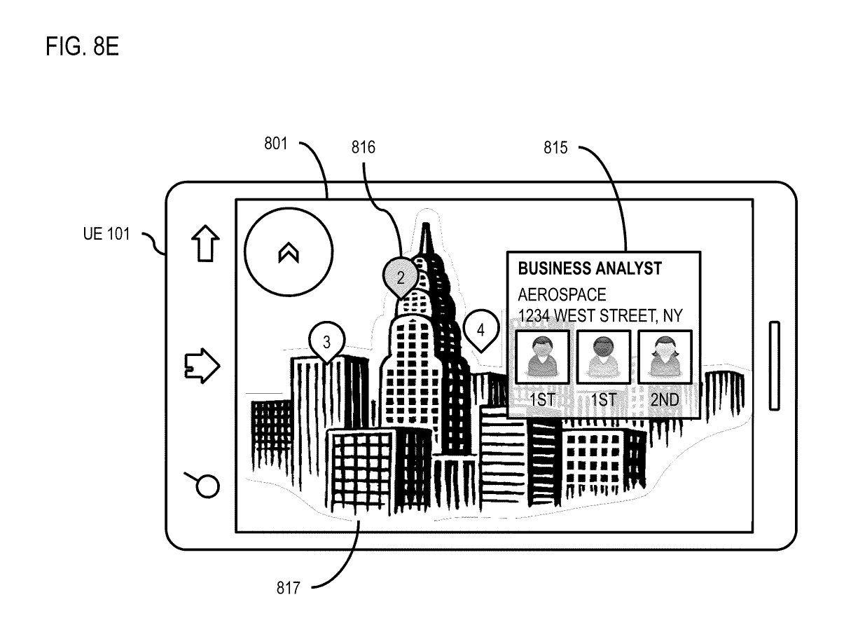

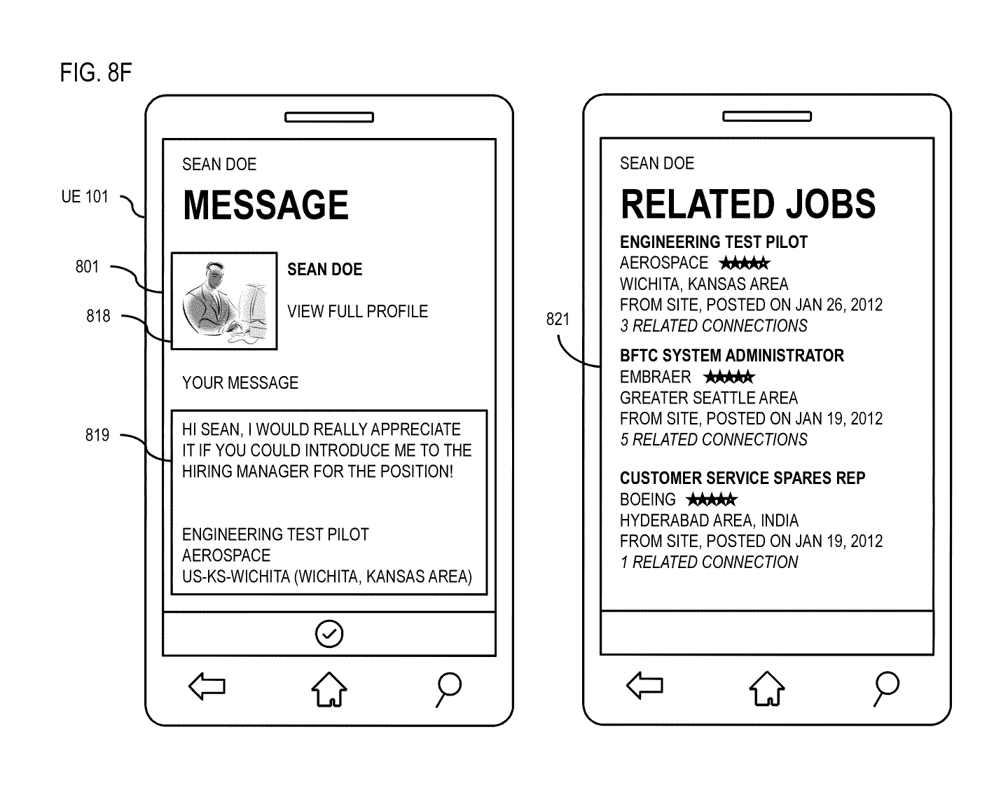

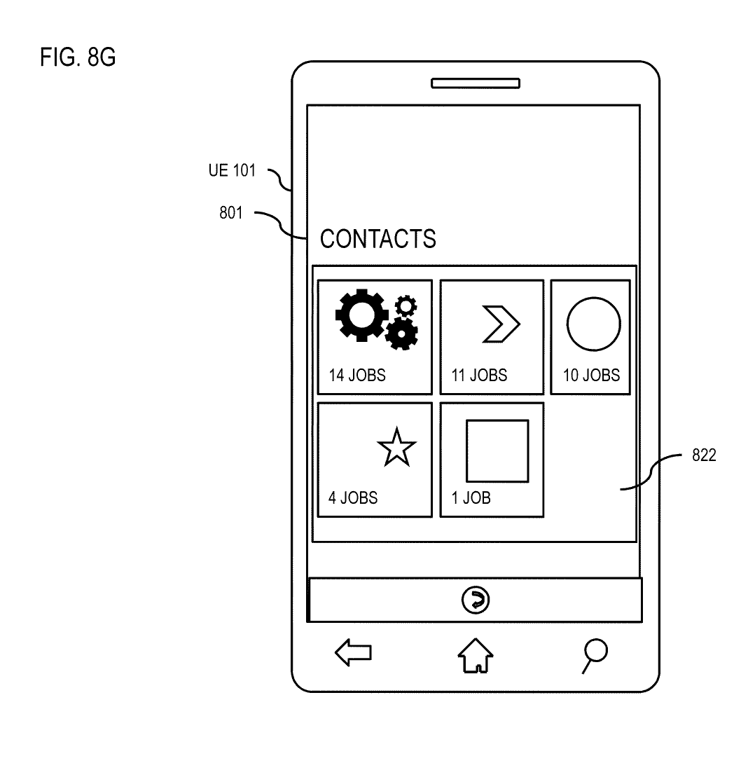

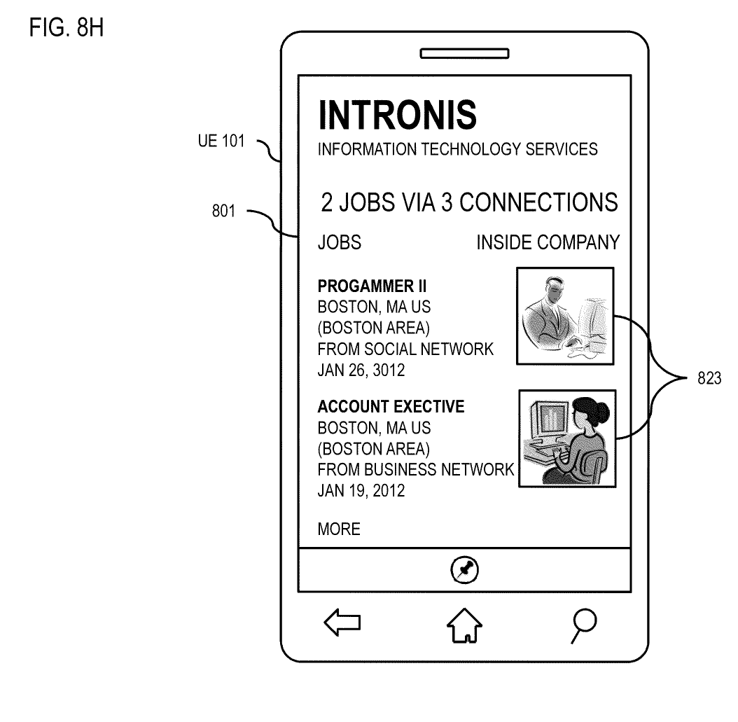

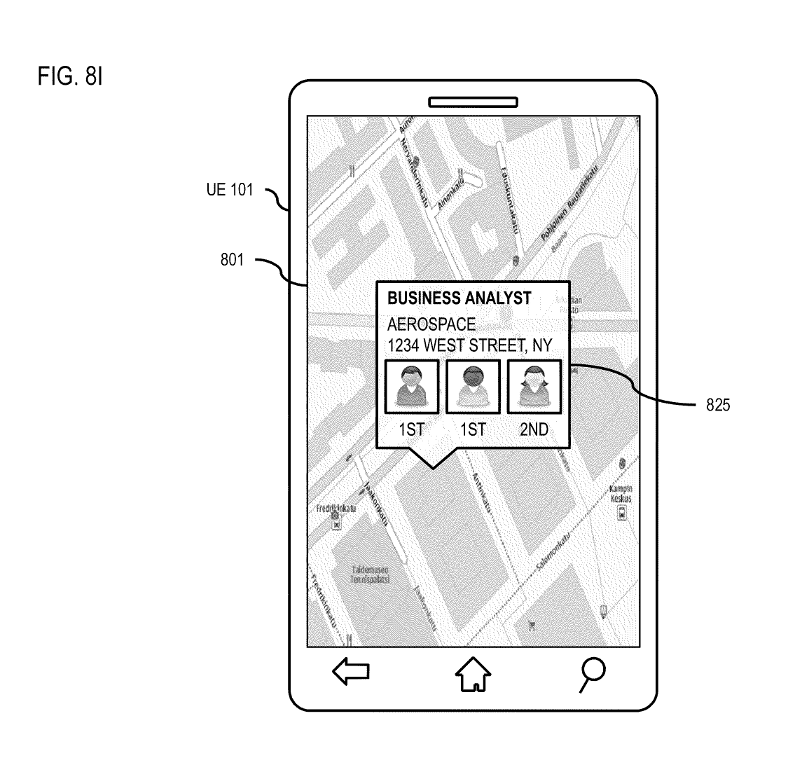

FIGS. 8A through 8I are diagrams of user interfaces utilized in the processes of FIGS. 4 through 6, according to various embodiments.

In FIG. 8A, a UE 101 presents a UI 801 wherein one or more applications is presented. In one embodiment, the applications may include an application 803 (e.g., Job Hub) which a user may utilize to request a search for employment/job opening, wherein the search may be conducted by the processing platform 109 for aggregating one or more results and information items associated with a potential position. The search may be based on one or more parameters, for example, jobs near the user geo-location. Further, in FIG. 8B, the UI 801 presents a plurality of information items on a potential job opening 802, which a user may apply to, save for later review, apply to, and the like via one or more UI options 805.

In FIG. 8C, the processing platform 109 may aggregate and present additional information associated with the job opening 802. For example the information items may include salary information 807 on the potential job opening and/or other alternative jobs 809. In one embodiment, the processing platform 109 may determine the information items from one or more sources, for example, a public access database, a governmental agency (e.g., a labor department), a specialized service provider, and the like.

In FIG. 8D, the processing platform 109 may determine one or more information items associated with a demographics of the area/neighborhood near a potential job opening. For example, commute time statistics 811 may include information commute times using public transportation, private transportation via freeways or toll-roads, and the like. In another example, the demographics information may include age distribution 813 near the job opening.

In FIG. 8E, the processing platform 109 may utilize an image capture and location information received from a UE 101 to cause a presentation of information associated with a job opening in AR at a UE 101. In one embodiment, the UI 801 may present the information as an aggregated indicator 815 wherein one or more potential job openings 816 may be layered over an image 817 (e.g., office buildings in the UE 101 view finder) via the UI 101. In one embodiment, the UE 101 may use one or more information items from a local and/or remote storage to add one or more information items for presenting in the AR.

In FIG. 8F, the processing platform 109 may present one or more contact information 818 which may be associated with a potential job opening, wherein a message 819 may be sent from the user to the contact 818 wherein the user may provide and/or request more information related to the user and/or the job opening. In one embodiment, the processing platform 109 may aggregate and present additional job openings 821, which the user may review and interact with.

In FIG. 8G, the processing platform 109 may aggregate contact information 822 from one or more social networking sites associated with the user, wherein one or more job openings may be determined and associated with one or more contacts 822. For example, a contact at a social networking site may indicate that there are one or more job openings at certain locations, certain companies, and the like. Further, in FIG. 8H, a user may interact with the listings in 822 to receive additional information 823 which may provide detailed information about a contact and one or more job openings which may be associated with the contact.

In FIG. 8I, the processing platform 109 may cause a presentation of information associated with one or more job openings and one or more contact information 825 on a map application, where the presentation may be in an AR environment. For example, the information may be presented over an image captured by a camera on the UE 101.

The processes described herein for processing and presenting aggregated information to a user via an augmented reality user interface may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to process and present aggregated information to a user via an augmented reality user interface as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of processing and presenting aggregated information to a user via an augmented reality user interface.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to processing and presenting aggregated information to a user via an augmented reality user interface. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for processing and presenting aggregated information to a user via an augmented reality user interface. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for processing and presenting aggregated information to a user via an augmented reality user interface, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for processing and presenting aggregated information to a user via an augmented reality user interface.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to process and present aggregated information to a user via an augmented reality user interface as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of processing and presenting aggregated information to a user via an augmented reality user interface.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to processing and presenting aggregated information to a user via an augmented reality user interface. The memory 1005 also stores the data associated with or generated by the execution of the inventive steps.

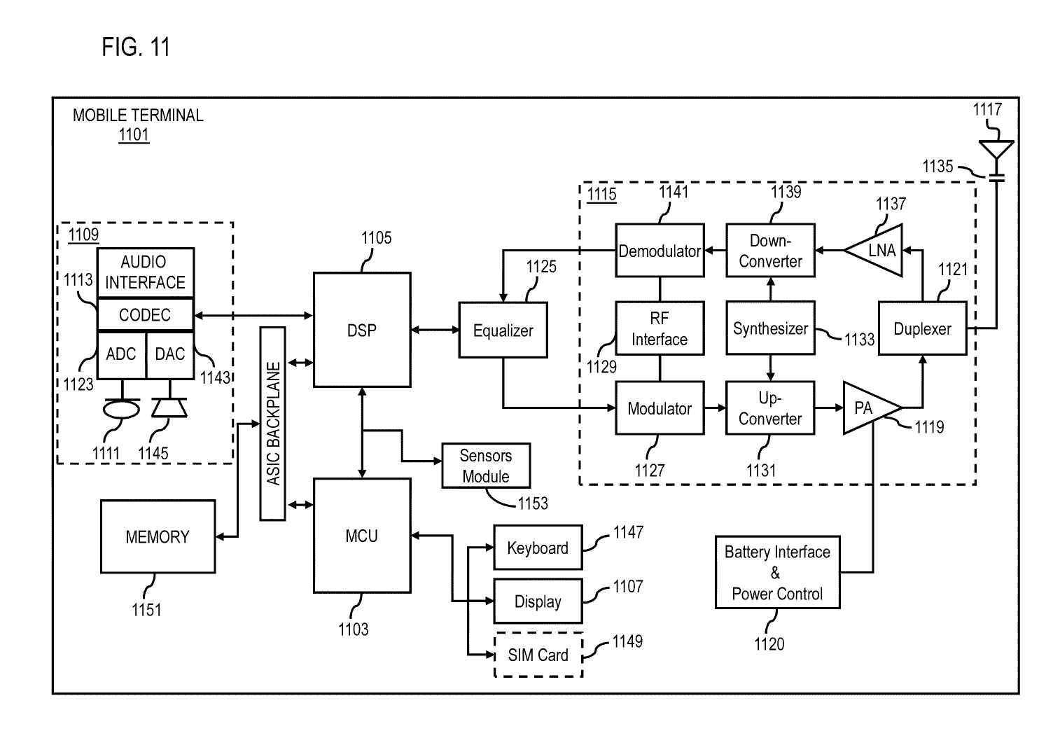

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of processing and presenting aggregated information to a user via an augmented reality user interface. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of processing and presenting aggregated information to a user via an augmented reality user interface. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to process and present aggregated information to a user via an augmented reality user interface. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of location information, contextual information, or a combination thereof associated with at least one user to determine one or more parameters for causing an aggregation of information across a plurality of data sources;
an initiation of the aggregation of the information based, at least in part, on the one or more parameters; and
a presentation of the aggregation of the information in an augmented reality user interface,
wherein the aggregation of the information includes, at least in part, location-based content

2. A method of claim 1, wherein the (1) data and/or (2) information and/or (3) at least one signal are further based, at least in part, on the following:
a processing of the location information, contextual information, or a combination thereof to determine social networking information associated with the at least one user,
wherein the aggregation of the information is further based, at least in part, on the social networking information.

3. A method of claim 2, wherein the (1) data and/or (2) information and/or (3) at least one signal are further based, at least in part, on the following:
a processing of the social networking information to determine one or more contacts related to the at least one user that are associated with the aggregation of the information.

4. A method of claim 1, wherein the (1) data and/or (2) information and/or (3) at least one signal are further based, at least in part, on the following:
at least one determination of personal profile information for the at least one user,
wherein the aggregation of the information is further based, at least in part, on the personal profile information.

5. A method of claim 1, wherein the (1) data and/or (2) information and/or (3) at least one signal are further based, at least in part, on the following:
a storage of at least a portion the aggregation of the information based, at least in part, on one or more user interactions with the augmented reality interface.

6. A method of claim 1, wherein the (1) data and/or (2) information and/or (3) at least one signal are further based, at least in part, on the following:
a compilation of user information related to the aggregation of the information.

7. A method of claim 6, wherein the aggregation of the information relates, at least in part, to one or more postings, and wherein the compilation relates, at least in part, to one or more applications for the one or more postings.

8. A method of claim 7, wherein the aggregation of the information relates, at least in part, to one or more organizations, one or more geographic areas, demographic information, or a combination thereof associated with the one or more postings.

9. A method of claim 1, wherein the (1) data and/or (2) information and/or (3) at least one signal are further based, at least in part, on the following:
a recommendation of at least a portion of the aggregation of the information based, at least in part, on the location information, the contextual information, the one or more parameters, user profile information or a combination thereof.

10. A method of claim 1, wherein the (1) data and/or (2) information and/or (3) at least one signal are further based, at least in part, on the following:
a storage of the one or more parameters, the aggregation of the information, the location information, the contextual information, or a combination thereof as historical information for the at least one user, as reusable information for one or more other users, or a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of location information, contextual information, or a combination thereof associated with at least one user to determine one or more parameters for causing an aggregation of information across a plurality of data sources;
cause, at least in part, an initiation of the aggregation of the information based, at least in part, on the one or more parameters; and
cause, at least in part, a presentation of the aggregation of the information in an augmented reality user interface,
wherein the aggregation of the information includes, at least in part, location-based content.

12. An apparatus of claim 11, wherein the apparatus is further caused to:
process and/or facilitate a processing of the location information, contextual information, or a combination thereof to determine social networking information associated with the at least one user,
wherein the aggregation of the information is further based, at least in part, on the social networking information.

13. An apparatus of claim 12, wherein the apparatus is further caused to:
process and/or facilitate a processing of the social networking information to determine one or more contacts related to the at least one user that are associated with the aggregation of the information.

14. An apparatus of claim 11, wherein the apparatus is further caused to:
determine personal profile information for the at least one user,
wherein the aggregation of the information is further based, at least in part, on the personal profile information.

15. An apparatus of claim 11, wherein the apparatus is further caused to:
cause, at least in part, a storage of at least a portion the aggregation of the information based, at least in part, on one or more user interactions with the augmented reality interface.

16. An apparatus of claim 11, wherein the apparatus is further caused to:
cause, at least in part, a compilation of user information related to the aggregation of the information.

17. An apparatus of claim 16, wherein the aggregation of the information relates, at least in part, to one or more postings, and wherein the compilation relates, at least in part, to one or more applications for the one or more postings.

18. An apparatus of claim 17, wherein the aggregation of the information relates, at least in part, to one or more organizations, one or more geographic areas, demographic information, or a combination thereof associated with the one or more postings.

19. An apparatus of claim 11, wherein the apparatus is further caused to:
cause, at least in part, a recommendation of at least a portion of the aggregation of the information based, at least in part, on the location information, the contextual information, the one or more parameters, user profile information or a combination thereof.

20. An apparatus of claim 11, wherein the apparatus is further caused to:
cause, at least in part, a storage of the one or more parameters, the aggregation of the information, the location information, the contextual information, or a combination thereof as historical information for the at least one user, as reusable information for one or more other users, or a combination thereof.

21. A method comprising:
processing and/or facilitating a processing of location information, contextual information, or a combination thereof associated with at least one user to determine one or more parameters for causing an aggregation of information across a plurality of data sources;
causing, at least in part, an initiation of the aggregation of the information based, at least in part, on the one or more parameters; and
causing, at least in part, a presentation of the aggregation of the information in an augmented reality user interface,
wherein the aggregation of the information includes, at least in part, location-based content.

22. A method of claim 21, further comprising:
processing and/or facilitating a processing of the location information, contextual information, or a combination thereof to determine social networking information associated with the at least one user,
wherein the aggregation of the information is further based, at least in part, on the social networking information.

23. A method of claim 22, further comprising:
processing and/or facilitating a processing of the social networking information to determine one or more contacts related to the at least one user that are associated with the aggregation of the information.

24. A method of any of claims 21-23, further comprising:
determining personal profile information for the at least one user,
wherein the aggregation of the information is further based, at least in part, on the personal profile information.

25. A method of any of claims 21-24, further comprising:
causing, at least in part, a storage of at least a portion the aggregation of the information based, at least in part, on one or more user interactions with the augmented reality interface.

26. A method of any of claims 21-25, further comprising:
causing, at least in part, a compilation of user information related to the aggregation of the information.

27. A method of claim 26, wherein the aggregation of the information relates, at least in part, to one or more postings, and wherein the compilation relates, at least in part, to one or more applications for the one or more postings.

28. A method of claim 27, wherein the aggregation of the information relates, at least in part, to one or more organizations, one or more geographic areas, demographic information, or a combination thereof associated with the one or more postings.

29. A method of any of claims 21-28, further comprising:
causing, at least in part, a recommendation of at least a portion of the aggregation of the information based, at least in part, on the location information, the contextual information, the one or more parameters, user profile information or a combination thereof.

30. A method of any of claims 21-29, further comprising:
causing, at least in part, a storage of the one or more parameters, the aggregation of the information, the location information, the contextual information, or a combination thereof as historical information for the at least one user, as reusable information for one or more other users, or a combination thereof.

31. An apparatus comprising:
at least one processor; and
at least one memory including computer program code for one or more programs,
the at least one memory and the computer program code configured to, with the at least one processor, cause the apparatus to perform at least the following,
process and/or facilitate a processing of location information, contextual information, or a combination thereof associated with at least one user to determine one or more parameters for causing an aggregation of information across a plurality of data sources;
cause, at least in part, an initiation of the aggregation of the information based, at least in part, on the one or more parameters; and
cause, at least in part, a presentation of the aggregation of the information in an augmented reality user interface,
wherein the aggregation of the information includes, at least in part, location-based content.

32. An apparatus of claim 31, wherein the apparatus is further caused to:
process and/or facilitate a processing of the location information, contextual information, or a combination thereof to determine social networking information associated with the at least one user,
wherein the aggregation of the information is further based, at least in part, on the social networking information.

33. An apparatus of claim 32, wherein the apparatus is further caused to:
process and/or facilitate a processing of the social networking information to determine one or more contacts related to the at least one user that are associated with the aggregation of the information.

34. An apparatus of any of claims 31-33, wherein the apparatus is further caused to:
determine personal profile information for the at least one user,
wherein the aggregation of the information is further based, at least in part, on the personal profile information.

35. An apparatus of any of claims 31-34, wherein the apparatus is further caused to:
cause, at least in part, a storage of at least a portion the aggregation of the information based, at least in part, on one or more user interactions with the augmented reality interface.

36. An apparatus of any of claims 31-35, wherein the apparatus is further caused to:
cause, at least in part, a compilation of user information related to the aggregation of the information.

37. An apparatus of claim 36, wherein the aggregation of the information relates, at least in part, to one or more postings, and wherein the compilation relates, at least in part, to one or more applications for the one or more postings.

38. An apparatus of claim 37, wherein the aggregation of the information relates, at least in part, to one or more organizations, one or more geographic areas, demographic information, or a combination thereof associated with the one or more postings.

39. An apparatus of any of claims 31-38, wherein the apparatus is further caused to:
cause, at least in part, a recommendation of at least a portion of the aggregation of the information based, at least in part, on the location information, the contextual information, the one or more parameters, user profile information or a combination thereof.

40. An apparatus of any of claims 31-39, wherein the apparatus is further caused to:
cause, at least in part, a storage of the one or more parameters, the aggregation of the information, the location information, the contextual information, or a combination thereof as historical information for the at least one user, as reusable information for one or more other users, or a combination thereof.

41. An apparatus of any of claims 31-40, wherein the apparatus is a computer system comprising one or more storage devices, one or more real-time processing elements, one or more static processing elements, or a combination thereof.

42. A computer-readable storage medium carrying one or more sequences of one or more instructions which, when executed by one or more processors, cause an apparatus to at least perform a method of at least one of claims 21-30.

43. An apparatus comprising means for performing a method of at least one of claims 21-30.

44. An apparatus of claim 43, wherein the apparatus is a mobile device further comprising:
user interface circuitry and user interface software configured to facilitate user control of at least some functions of the mobile device through use of a display and configured to respond to user input; and
a display and display circuitry configured to display at least a portion of a user interface of the mobile device, the display and display circuitry configured to facilitate user control of at least some functions of the mobile device.

45. A computer program product including one or more sequences of one or more instructions which, when executed by one or more processors, cause an apparatus to at least perform the steps of a method of at least one of claims 21-30.

46. A method comprising facilitating access to at least one interface configured to allow access to at least one service, the at least one service configured to at least perform a method of at least one of claims 21-30.

47. A method comprising facilitating a processing of and/or processing (1) data and/or (2) information and/or (3) at least one signal, the (1) data and/or (2) information and/or (3) at least one signal based, at least in part, on the method of any of claims 21-30.

48. A method comprising facilitating creating and/or facilitating modifying (1) at least one device user interface element and/or (2) at least one device user interface functionality, the (1) at least one device user interface element and/or (2) at least one device user interface functionality based, at least in part, on the method of any of claims 21-30.
